(19) United States
(12) Patent Application Publication
(10) Pub. No.: US 2007/0226043 A1
(43) Pub. Date: Sep. 27, 2007

(54) Computer System and Method for Optimized Provision of Manufactured Parts

(76) Inventors: Anton Pietsch, Singapore (SG); Alfred Pfisterer, Gmund (DE); Uve Czempik, Haag (DE); Peter Petraschka, St. Heinrich (DE)

Correspondence Address: SCHIFF HARDIN, LLP;PATENT DEPARTMENT, 6600 SEARS TOWER, CHICAGO, IL, 60606-6473, US

(21) Appl. No.: 11/574,446

(22) PCT Filed: Sep. 27, 2005
(86) PCT No.: PCT/EP05/10426

§ 371 Date: Apr. 4, 2007

(30) Foreign Application Priority Data
Sep. 29, 2004 (DE) 10 2004 047 328.5

(51) Int. Cl. G06Q 10/00

(52) U.S. Cl. 705/10

(57) ABSTRACT

In a computer system or method for optimized provision of production parts at a manufacturer, a demand for parts is detected with a manufacturer computer system. Data describing the demand are automatically provided over a data connection to at least one vendor computer system of a specific vendor, the data describing the demand for parts to be delivered by said vendor as an actual inventory level and a reorder level.

### BACKGROUND

The preferred embodiment concerns a computer system and a method for optimized provision of manufactured parts. It furthermore concerns a computer system and a method for automatic execution of orders of parts by a manufacturer given a vendor.

Manufacturers have conventionally ordered parts from vendors via exchange of an individual message that is typically communicated from the manufacturer to the vendor per letter, per fax or per e-mail. For this the manufacturers operate a purchasing department that receives the part requisitions of the individual departments of the manufacturer, formulates them into corresponding order jobs and communicates them to the respective vendors. The vendor thereupon delivers the ordered parts. The processing of the orders by the purchasing department represents a significant administrative expenditure that correspondingly incurs large costs and additionally leads to a delay in the order system. Furthermore, manufacturers normally operate a storage for parts required often and at regular intervals. The demand for the individual parts is determined in advance by the storage administration. For this there is suitable business management software with which the future demand for the individual parts can also be estimated and the inventory can be optimized. A high inventory level is disadvantageous in principle since it ties up capital.

A factory network with a plurality of factories arises from EP 0 752 134 B1. The factory network comprises a plurality of coordinated factories, of which each uses a planning coordination system. The factory network supplies products to a client sale entity that represents all activities after the manufacture such as, for example, distribution, wholesale activities and retail activities. The client sale entity communicates requisitions for products to the factory network. A requisition comprises such information as the part number, the required quantity and the delivery date. According to an output plan, the planning coordination system determines how each requisition from the client sale entity is answered. Each response should comprise such information as part number, accepted quantity, accepted data, for example. With this factory network the conventional order system with orders and order confirmation is thus replicated by means of a data network, whereby the conventional letters transmitted via mail or telefax are replaced by electronic messages.

A vendor system that comprises a data processing system with a memory for storage inventories, stock demand data etc. arises from US 2002/0072988 A1. According to one embodiment vendors are informed via e-mail in the event that the inventory falls below a predetermined value. The data processing system comprises a customer interface to the data storage that allows the customer to input corresponding customer orders. A vendor interface to the data storage allows the vendors to input vendor data such as, for example, the inventory of the vendor and the work progress of the vendor. In principle, in this known system a job is initially issued by the customer, to which job the vendor then correspondingly reacts (paragraph 15 in US 2003/0072988 A1). A web server can also be provided for input of these data. Data can also be downloaded by the customer and the vendor via this web server. The web server can also be provided with a function that graphically shows the inventories and with which future inventories can be graphically depicted. For simplification of the administrative expenditure, the order and the delivery can also occur under a blank purchase order (blanket purchase order). The individual purchase orders can also be listed on the web server, whereby the list of the customer orders, respectively comprising the delivery data and the desired delivery quantity, is stated for each part. The orders (=customer orders) and the deliveries are prepared in terms of data with this known data processing system and are designed so as to be retrievable by both sides. In this system (as conventionally) purchase orders are also generated and the corresponding deliveries are confirmed. The corresponding communication is recorded in terms of data and graphically prepared for both sides.

### SUMMARY

It is an object to achieve a system and a method with which the feed of parts for a production process can be largely automatically controlled. It is also an object to achieve a system and a method with which orders are automatically executed, whereby the administrative effort is reduced to a minimum.

In a computer system or method for optimized provision of production parts at a manufacturer, a demand for parts is detected with a manufacturer computer system. Data describing the demand are automatically provided over a data connection to at least one vendor computer system of a specific vendor, the data describing the demand for parts to be delivered by said vendor as an actual inventory level and a reorder level.

### BRIEF DESCRIPTION OF THE DRAWINGS

FIG. 1 schematically illustrates a computer system for automatic execution of orders,

FIGS. 2-5 respectively illustrate screen representations of a graphical user interface of a software product for execution of the inventive method; and

FIGS. 6A-6C show a complete data set for a part, which complete data set is provided to a vendor in a formatting suitable for printing.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

According to a first aspect of the preferred embodiment, at a manufacturer a manufacturer computer system is provided for detecting the demand for parts and a data connection to at least one vendor computer system of a specific vendor is provided for optimized provision of manufactured parts. The data describing the demand are thus automatically provided (via the data connection with the vendor computer system) as an actual inventory level and a reorder level of parts to be supplied by this vendor. A graphical display respectively occurs at the vendor computer system regarding data pertaining to the parts inventory, changes to the part that are planned by the manufacturers and/or concerning the parts quality.

The demand for parts to be supplied is detected with this notification system and then automatically provided to the respective vendors. The system thus associates the descriptive data for the demand with the respective vendors and provides them to the respective vendors via the data connection. The vendors can therefore supply correctly as needed. No separate order must be formulated and transmitted to the vendors. The communication of the data describing the demand occurs wholly automatically, whereby no order must be formulated and communicated to a vendor and the administrative expenditure is reduced to a minimum.

The manufacturer computer system advantageously uses a business administration software for automatic detection and determination of the demand percentage.

The graphical display can in particular occur in the form of what is known as a traffic light function in which the three data categories “parts stock”, “change stock” and “quality stock” and/or the graphical displays of the data regarding these categories are respectively shown in traffic light colors “red”, “green” and/or “yellow”. For the user of the vendor computer system it can thereby be recognized very easily, quickly and clearly, virtually “at a glance” for a plurality of parts, whether a need for action exists on his part with regard to the fulfillment of his vendor obligation, with regard to the part-related quality criteria and/or with regard to its specification conformity. This saves time on the one hand relative to laborious evaluation of the parts data and on the other hand ensures that sufficient processable parts are always available at the manufacturers, i.e. that the production process there is significantly better and more reliable.

According to a second aspect of the preferred embodiment (that can be executed together with or also independent of the first aspect of the preferred embodiment), a computer system for automatic execution of orders of parts at a vendor by a manufacturer comprises:
a manufacturer computer system for detection of the demand for parts,
a data connection to at least one vendor computer system of a specific vendor,

whereby the data describing the demand are automatically provided to the vendor computer system (via the data connection) as an actual inventory level and a reorder level, and no separate orders are formulated.

The method according to the second aspect of the preferred embodiment thus differs fundamentally from the known methods explained above, in which specific purchase orders are respectively generated and these are then correspondingly fulfilled via delivery of the goods. In contrast to this, in the computer system of the preferred embodiment only demand data are generated and provided to the vendor without a delivery acknowledgement or the like having to occur. Thus only the data with regard to the demand are provided to the vendor with the method.

The data describing the demand advantageously correspond to the desired inventory level, in particular of a commission inventory, such that the vendor independently and self-dependently sustains the inventory level. For this it is appropriate that specific stock monitoring variables are detected such as, for example, a reorder level, a maximum inventory level and a minimum inventory level that are regularly and automatically adapted using the acquired demand data and are to be maintained by the vendor. Via the automatic detection of these stock monitoring variables and transmission to him, the vendor has the advantage that he can adjust his production to these and plan for the long term, whereby planning reliability exists for him, which is a significant cost advantage.

For the manufacturer the advantage here is that, via the determination of the minimum inventory level and the automatic communication to the vendor, it is ensured that the inventory always comprises a determined minimum stock that ensures the continuous production of corresponding products. The manufacturer thus has the assurance that his production is not interrupted by delivery bottlenecks and additionally that no personnel at the manufacturer must make decisions about individual part orders since the vendor is informed in a wholly automatic manner about the demand and the minimum inventory level.

The reorder level is the inventory level at which, upon being underrun, the vendor is informed that the parts are to be delivered. An underrun of the reorder level means that a demand for parts exists, whereby the demand is at least the difference between the reorder level and the actual inventory level. Via the automatic communication of the reorder level and of the actual inventory level, the vendor knows the exact demand at the manufacturer.

Furthermore, it is appropriate to automatically transmit messages to the vendor that indicate to him whether he has met the inventory monitoring values. These messages are advantageously represented as status signals in the form of a colored point on a graphical user interface, whereby a red colored point means that the vendor must immediately become active, a yellow colored point means that a reaction by the vendor is at least required soon and a green colored point means that no activity is currently required. The colored point is, for example, red when the inventory level of the corresponding part is less than the safety level. The colored point is yellow when the inventory level is equal to or greater than the safety level and smaller than or equal to the reorder level. The colored point is green when the inventory level is greater than the reorder level.

Not only are the inventory data describing the demand communicated with these status signals, but rather status signals are also output that describe the correct specification (revision level) or the correct quality (quality level) of the parts and correspondingly inform the vendors. The manufacturer can hereby automatically control the parts delivery for his production with regard to the demand, the quality and the specification. The parts delivery for the production process is thus entirely automated with regard to these three requirements (demand, quality and specification). In this embodiment the computer system thus represents an automatic control device for controlling the parts flow for the production.

Via unambiguous signals the status signals indicate whether predetermined thresholds (such as the reorder level, maximum inventory level and safety inventory level) are exceeded or underrun, or they express predetermined requirements or properties of the parts deliveries such as, for example, that a change is intended or has already been decided or that parts have been taken from the production.

These status signals comprise a limited number of signal values such that all status signals for a specific part to be supplied can be clearly shown on one page and advantageously in one line. The status signals are advantageously designed in the form of different colored points that can be shown in a very compact manner and very clearly. However, in principle it is also possible to provide other status signals instead of colored points, such as, for example, corresponding signal words or signal letters. For this aspect of the preferred embodiment it is essential that the status signals can be shown clearly and in a compact manner so that the vendor can recognize with one glance all requirements placed on him with regard to a part.

Furthermore, it is appropriate to provide the vendor with information regarding last goods movements. The vendor can thus monitor whether a goods shipment has already arrived at the manufacturer and has been accounted for in the manufacturer computer system of the manufacturer. Multiple deliveries can thus be avoided since a demand message is registered in the system not upon shipment of the goods from the vendor but rather only upon arrival of the goods at the manufacturer, such that a demand is furthermore displayed to the vendor, although he has already shipped the goods.

In the preferred embodiment regarding the planned goods movements are provided to the vendor, whereby the vendor can plan his production over an even longer term.

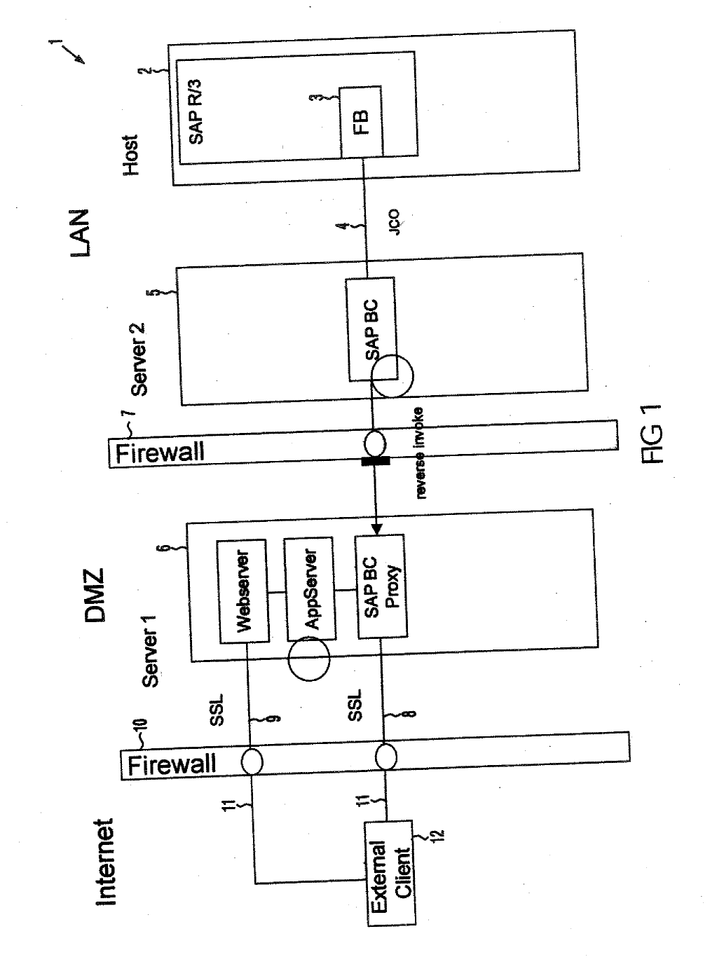

FIG. 1 schematically shows a computer system 1 of the preferred embodiment for automatic execution of orders of parts by a manufacturer at a vendor. The computer system 1 comprises a central computer system that here is represented by a host computer 2 on which a business management software (such as, for example, SAP R/3) is stored and executed. The host computer is connected with an internal server 5 by means of a data line 4 via an interface 3. This interface 3 is designated as a function module FB and reads data from the business management software and transmits this data to the internal server 5. A program (BC: Business Connector) for transmission of the data to an external server 6 is stored on the internal server 5 and is executed there. A first internal firewall 7 (that should prevent that an unauthorized party can use the data connection between the internal server 5 and the external server 6) is arranged between the internal server 5 and the external server 6.

An e-mail server program (SAP BC Proxy), a web server program and an application server program are stored on the external server 6 and are executed there. The e-mail server and web server are connected with an external firewall 10 with separate data lines 8, 9. There data lines 11 (that are components of a WAN (Wide Area Network) such as, for example, the Internet) lead to the computer systems 12 of the vendors. The application server program generates a user interface and loads the data obtained from the e-mail server program into the user interface. The user interface so provided with data is transferred from the web server program to the vendor computer system via the data lines 9, 11. For simplification of the drawing a single vendor computer system 12 is shown in FIG. 1.

The computer system 2, 5, 6 of the manufacturer determines the demand (for example using the business management software on the host computer 2) and automatically provides data describing the demand to the computer system of the vendor by means of the server 5, 6. This can in principle occur in two different ways. On the one hand the data can be provided via the web server on the external server 6 for retrieval as Internet pages. On the other hand, the data can be automatically sent as e-mail to the computer system of the vendor by means of the e-mail server of the external server 6.

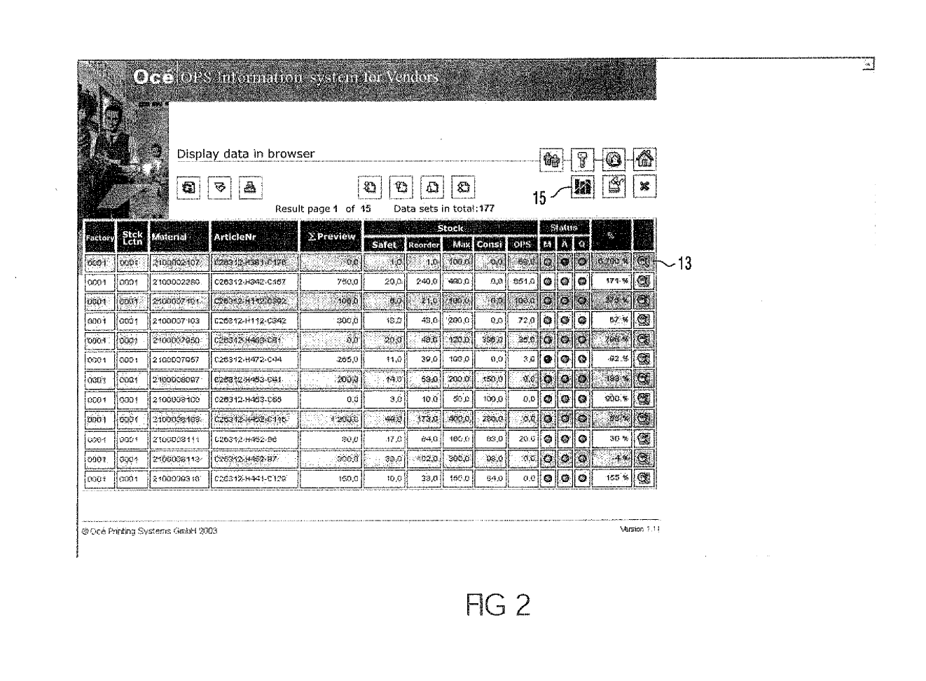

Examples of the corresponding Internet pages are shown in FIGS. 2 through 5.

FIG. 2 shows a tabular representation of the corresponding data, whereby the table comprises a plurality of columns that are designated with Factory, StckLctn, Material, ArticleNr, ΣPreview, Inventory, Status and with %. The columns Inventory and Status are subdivided into further sub-columns that are explained in detail below.

The column Factory contains the number of the factory in which the part is stocked or to which the part must be delivered. The designation StckLctn is an abbreviation for the stock location. This column contains a number that designates the stock location at which the part is stored within a specific factory.

The columns Material and ArticleNr (which stands for Article Number) respectively contain an alphanumeric designation or number for the part or the article, whereby in the present exemplary embodiment the number designated with Material is preferably used by the stock administration and the business management administration whereas the number designated with ArticleNr is preferably used by the development department and the production of the factory.

The column designated with ΣPreview indicates to the vendor a preview of the future product demand. This is explained in further detail below.

The column Inventory is of essential importance for the preferred embodiment because it implicitly shows the demand for parts. A plurality of identification numbers of the inventory level in factories is specified for each part in the column Inventory. These identification numbers are a safety level (Safet), a reorder level (Reorder), a maximum inventory level (Max), a consignment level (Consi) and an OPS level (OPS).

The safety level is the minimum inventory level that should always be on hand in the storage. The safety level is calculated from the average daily demand multiplied with a safety buffer time.

The reorder level is the inventory level given the underrun of which the vendor is informed that the parts are to be delivered. An underrun of the reorder level means that a demand for parts exists, whereby the demand is at least the difference between the reorder level and the actual inventory level. The reorder level is calculated from the product between the average daily demand and the sum of a plan delivery time and a buffer time.

The maximum inventory level specifies the maximum number of a specific type of parts that should be stocked in the storage. The maximum inventory level is calculated with the same product as the reorder level, whereby, however, a larger buffer time is used than in the reorder level.

The consignment level is the current actual level of all parts of the inventory that are located in consignment. Consignment means that the ownership of the parts still resides with the vendor. Only when the parts are removed from the storage does the possession of the parts pass to the factory.

The current inventory level or actual inventory level of all parts in storage whose ownership already resides with the factory is designated as the OPS level in the present example.

The sum made up of the consignment level and the OPS level indicates the total actual inventory level.

The column status is subdivided into three sub-columns for a reorder status (M), a modification status (M) and a quality status (Q).

These sub-columns situated next to one another respectively exhibit a colored point that can assume the colors red or green and possibly yellow and signal a message to the vendor, similar to a traffic light.

The colored point or the traffic light of the reorder level is red when the actual inventory level is lower than the safety level. If the actual inventory level is greater than or equal to the safety level and simultaneously smaller than or equal to the reorder level, the traffic light is yellow. If the actual inventory level is greater than the reorder level, the reorder level traffic light is green.

For the vendor, a transition from green to yellow means that parts of the corresponding goods are to be delivered until at least the reorder level is reached again. The maximum inventory level should not be exceeded. This transition thus represents information about the demand for parts.

The traffic light with regard to the inventory modification can in turn adopt the colors green, yellow and red. It is green when no modification is intended. It is yellow when the manufacturer plans a change to the part and it is red when a change has been decided on by the manufacturer. When the vendor delivers the first parts that correspond to the change the traffic light is again reset from red to green.

The traffic light for the quality inventory can only adopt the colors green and red. The color red means that corresponding parts are taken out of production due to defects and have been transferred into what is known as a quality inventory. The parts located in the quality inventory are examined for whether they have caused defects in the production. If no parts are in the quality inventory, the traffic light is green.

The values for the inventory level and the status are automatically adjusted and adapted. The safety level, reorder level and maximum inventory level depend on the average daily demand. This daily demand is updated at regular intervals of, for example, one week, two weeks, one month and the corresponding inventory values are adapted. The consignment inventory level of the OPS inventory level indicate the current numbers of the parts located in storage. The manufacturer will preferably keep the OPS inventory level low and store the parts in the consignment inventory since he thus saves significant capital costs. However, if parts are removed from the storage for development or production and are not used there due to further circumstances, they are returned to the storage and are then to be added to the OPS inventory level even if the corresponding vendor should operate a consignment storage at the manufacturer.

The traffic lights for the status values automatically switch over upon excess or underrun of the corresponding threshold values.

The percentile values with which the actual inventory level exceeds (positive percentile value) or underruns (negative percentile value) the reorder level are indicated in the % column. Negative percentile values indicate to the vendor that he has to deliver a corresponding percentile of goods relative to the reorder level.

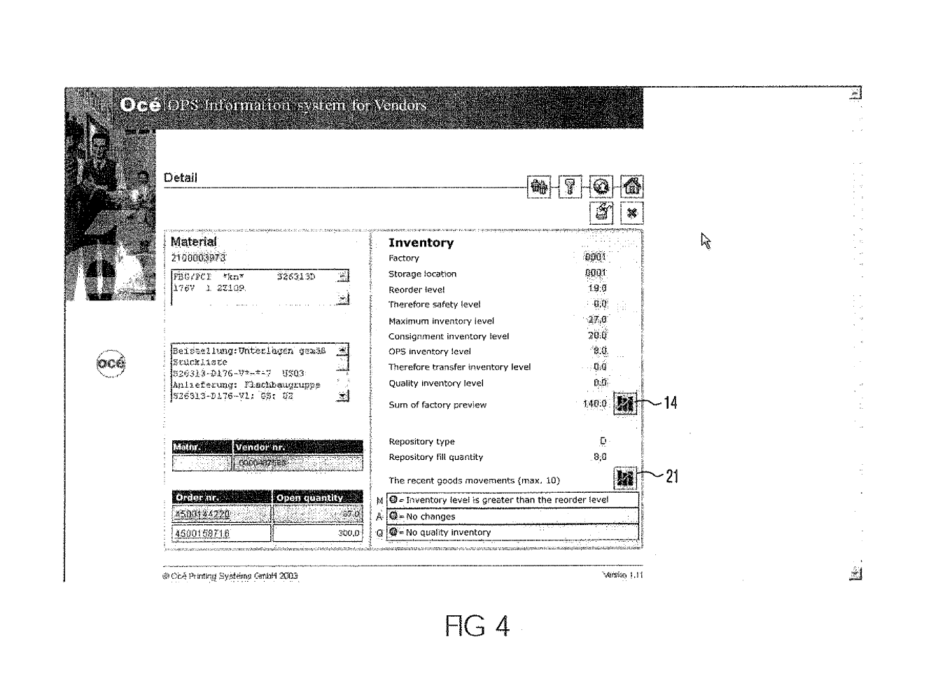

An icon 13 is indicated in the last column of the table. Upon clicking on this icon 13 a further Internet page is opened in which the details with regard to a good or with regard to a part are shown (FIG. 4). The complete material or part designation as well as the purchase order text are also specified herein in addition to the data that are specified in the table.

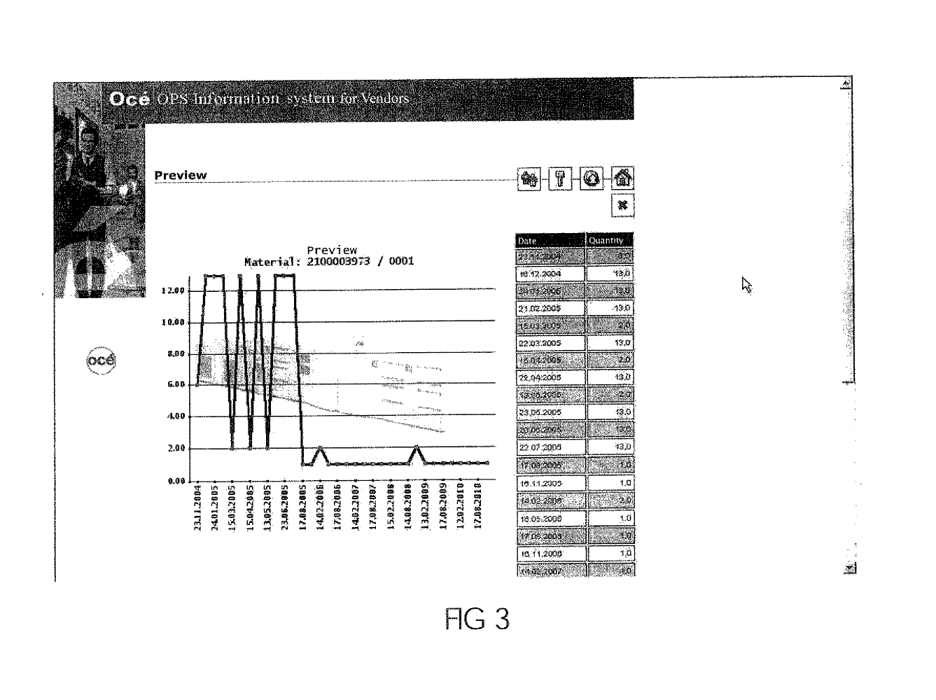

In addition to the designation “Sum Preview Factory”, a number that represents a preview of the planned parts demand in the future is specified in this detail view. In addition to this view an icon 14 is indicated for clicking. Upon clicking on this icon a further Internet page is displayed that shows the planned preview in the form of a diagram and in the form of a table (FIG. 3). Using this preview a vendor can plan his production capacity in the long term. In the example shown in FIG. 3 the vendor knows that he must produce relatively steadily for a certain time. He must then significantly raise production temporarily. A phase follows this in which he must adjust the production. Only a minimal production for the replacement demand must be maintained.

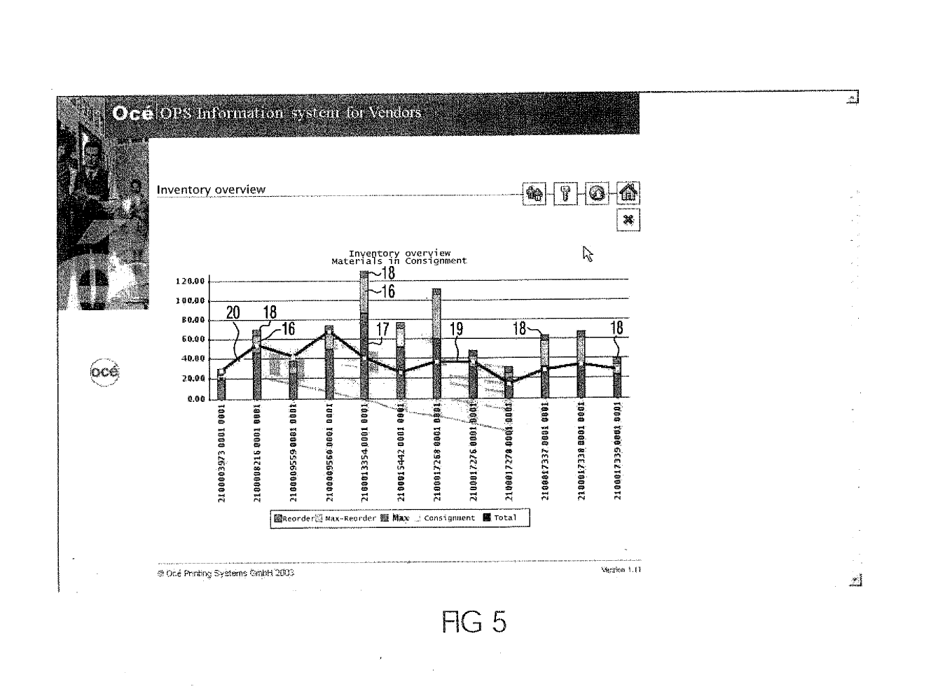

By clicking on the icon 15 in FIG. 2, an Internet page with the inventory overview of the parts of a vendor in the storage is shown (FIG. 5). A vertical bar is respectively shown with regard to a part, in which vertical bar the region 16 between the maximum inventory level and the reorder level is marked green, the region 17 below the reorder level is marked red, and the upper limit 18 of the maximum inventory level is also marked red. The actual inventory level is represented by a black line 19. A yellow line 20 shows the consignment level in the event that this differs from the actual inventory level.

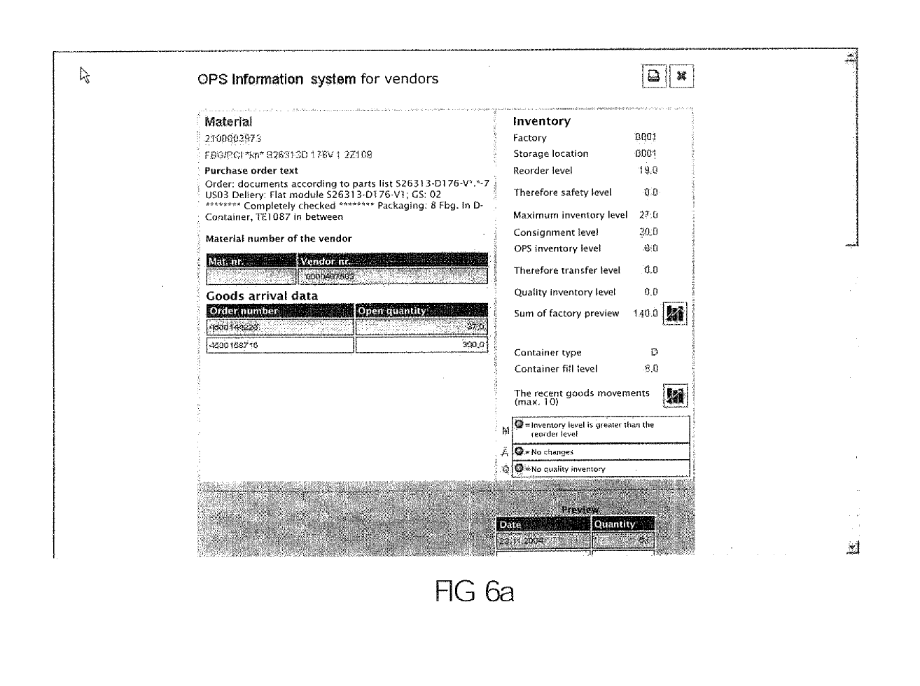

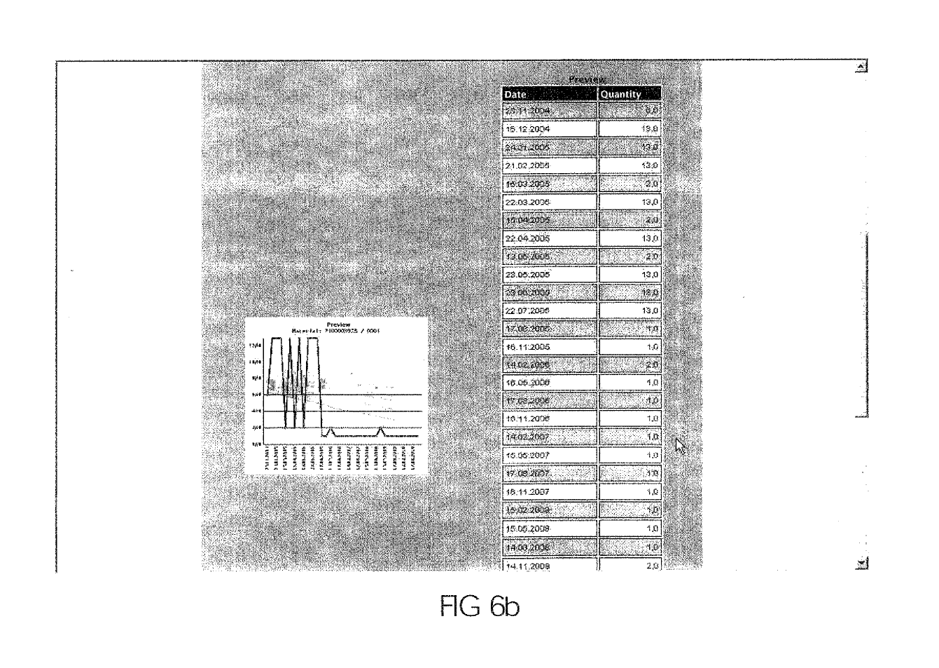

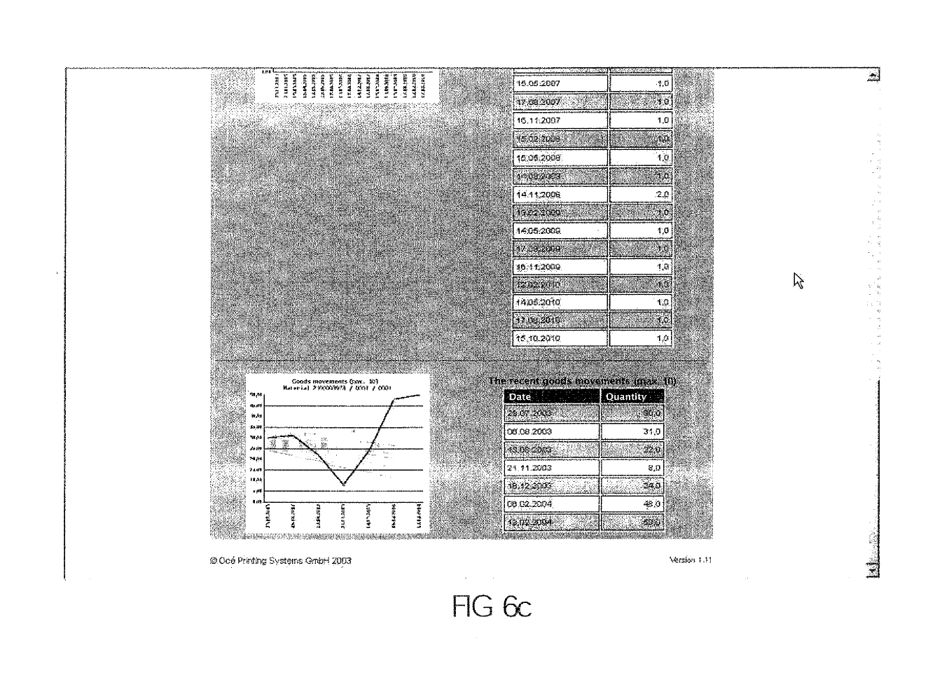

FIGS. 6a-6c show all information regarding a specific part in a format suitable for printout on a printer. The first segment (top of FIG. 6a) corresponds to the detail specifications from FIG. 4. The second segment (bottom of FIG. 6a and FIG. 6b) comprises the data regarding the preview corresponding to FIG. 3 and the third segment (FIG. 6c) displays the data as well as a diagram regarding the last goods movements. The number of the lists regarding the goods movements is thus limited to 10. Since here the vendor can track the last goods movements that have arrived at the manufacturer, it can determine whether a delivery recently shipped has already been entered into the storage or whether it is still on the transport route. A duplicate delivery is thus avoided when it is displayed to the vendor that a demand exists, although the delivery is located on the transport route.

These representations with regard to the goods movement can also be retrieved by clicking on an icon 21 in FIG. 4. A further Internet page is hereupon called up on which the data and the diagram with regard to the last goods movements are shown.

All data that are comprised in the print representation shown in FIGS. 6a through 6c are also transmitted upon request to the vendor computer system 12 per e-mail via the data lines 8, 11 by means of the e-mail server.

The preferred embodiment is explained above using a computer system. The preferred embodiment also comprises the method executed with the computer system as well as a software product that executes the method when it is loaded into the computer system and executed.

The preferred embodiment can be briefly summarized as follows:

The preferred embodiment concerns a computer system and a method for automatic execution of orders of parts at a vendor by a manufacturer.

The preferred embodiment is characterized in that the demand for parts is automatically detected at the manufacturer and the corresponding data are provided to the vendor.

It is thus not necessary to formulate and to ship individual orders. The administrative expenditure is significantly reduced

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-39. (canceled)

40. A computer system for optimized provision of production parts at a manufacturer, comprising:
a manufacturer computer system which detects demand for the parts; and
a data connection to at least one vendor computer system of a specific vendor, data describing the demand being automatically provided to the vendor computer system via the data connection as an actual inventory level and a reorder level of parts to be delivered by said vendor, and a graphical display being provided at the vendor computer system concerning data for at least one of an inventory level of the production parts, changes to the parts planned by the manufacturer, or parts quality.

41. A computer system according to claim 40 wherein the manufacturer computer system is designed for detection of an inventory level of a storage, whereby the inventory levels that are relevant for a specific vendor are also automatically provided to the vendor computer system of said vendor over the data connection.

42. A computer system according to claim 40 wherein the manufacturer computer system is designed for detection of at least one of the inventory monitoring variables comprising a reorder level, a maximum inventory level, or a safety level that are regularly and automatically adapted using the detected demand data.

43. A computer system according to claim 42 wherein the reorder level is calculated from an average daily demand of the respective part multiplied with a sum from a plan delivery time and a first buffer time.

44. A computer system according to claim 43 wherein the maximum inventory level is calculated from an average daily demand of the respective part multiplied with a sum from a plan delivery time and a second buffer time, whereby the second buffer time is greater than the first buffer time.

45. A computer system according to claim 44 wherein the safety level is calculated from an average daily demand of a respective part multiplied with a third buffer time.

46. A computer system according to claim 42 wherein with regard to each part, the manufacturer computer system generates at least one status signal as to whether the inventory level of the part is at least one of less than the safety level, equal to or greater than the safety level, or whether the inventory level is less than or equal to the reorder level or greater than the reorder level.

47. A computer system according to claim 42 wherein a message is shown in the form of a colored point on a graphical user interface, whereby the colored point is red when the inventory level of the part is less than the safety level, the colored point is yellow when the inventory level is equal to or greater than the safety level and less than or equal to the reorder level, and the colored point is green when the inventory level is greater than the reorder level.

48. A computer system according to claim 40 wherein a status signal with regard to a respective part is output by the manufacturer computer system to the corresponding vendor computer system via the data connection, the status signal indicating whether a change of the corresponding part is not planned or is planned or has already been executed.

49. A computer system according to claim 48 wherein the status signal is shown in the form of a colored point on a graphical user interface.

50. A computer system according to claim 49 wherein the colored point is green when no change is planned, the colored point is yellow when a change is planned and the colored point is red when a change has already been executed.

51. A computer system according to claim 40 wherein a status signal with regard to a respective part is output by the manufacturer computer system to the corresponding vendor computer system via the data connection, the status signal indicating whether or not goods of the corresponding part have been received in a quality storage due to problems in production.

52. A computer system according to claim 51 wherein the status signal is shown in the form of a colored point on a graphical user interface, the colored point is green when no corresponding goods are located in the quality storage, and the colored point is red when the goods are located in the quality storage.

53. A computer system according to claim 40 wherein a percentile deviation of the actual inventory level of each part from the reorder level is shown.

54. A computer system according to claim 40 wherein the data connection comprises a WAN, LAN, the Internet, or an intranet.

55. A computer system according to claim 40 wherein the manufacturer computer system comprises at least one host computer and at least one server, a firewall being arranged between the server and the data connection.

56. A computer system according to claim 55 wherein the manufacturer computer system comprises an internal server connected with the host computer and comprises an external server connected on the one hand with the internal server and on the other hand with the data connection, whereby a first firewall is arranged between the internal server and the external server and a second firewall is arranged between the external server and the data connection.

57. A computer system according to claim 56 wherein a web server is provided on the external server as a connection for Internet applications and a mail server is provided on the external server for data exchange via e-mail.

58. A computer system for automatic execution of orders of parts at a vendor by a manufacturer, comprising:
a manufacturer computer system which detects demand for the parts; and
a data connection to at least one vendor computer system of a specific vendor data, with regard to the demand for parts to be supplied by said vendor being automatically provided to the vendor computer system via the data connection as an actual inventory level and a reorder level and no separate orders being formulated.

59. A method for optimized provision of production parts at a manufacturer, comprising the steps of:
detecting a demand for parts with a manufacturer computer system;
automatically providing data describing the demand over a data connection to at least one vendor computer system of a specific vendor, the data describing the demand for parts to be delivered by said vendor as an actual inventory level and a reorder level; and
providing a graphical display at the vendor computer system concerning data for at least one of the parts inventory level, changes to the parts planned by the manufacturer, or parts quality.

60. A method according to claim 59 wherein the manufacturer computer system is used for detection of an inventory level of a storage, whereby the inventory levels relevant for a specific vendor are also automatically provided to the vendor computer system of said vendor over the data connection.

61. A method according to claim 59 wherein inventory-monitoring variables comprising at least one of reorder level, maximum inventory level, or a safety level are regularly and automatically adapted using the detected data describing the demand.

62. A method according to claim 61 wherein the reorder level is calculated from an average daily demand of the respective part multiplied with a sum from a plan delivery time and a first buffer time.

63. A method according to claim 62 wherein the maximum inventory level is calculated from the average daily demand of the respective part multiplied with the sum from the plan delivery time and a second buffer time, whereby the second buffer time is greater than the first buffer time.

64. A method according to claim 61 wherein the safety level is calculated from an average daily demand of the respective part multiplied with a buffer time.

65. A method according to claim 61 wherein with regard to each part, a status signal is generated in the manufacturer computer system as to whether the inventory level of the part is less than the safety level, equal to or greater than the safety level, or whether the inventory level is less than or equal to the reorder level or greater than the reorder level.

66. A method according to claim 61 wherein a message is shown in the form of a colored point on a graphical user interface, whereby the colored point is red when the inventory level of the part is less than the safety level, the colored point is yellow when the inventory level is equal to or greater than the safety level and less than or equal to the reorder level, and the colored point is green when the inventory level is greater than the reorder level.

67. A method according to claim 59 wherein a status signal with regard to a respective part and generated at the manufacturer computer system is provided via the data connection to the corresponding vendor computer system, said status signal indicating whether or not goods of the corresponding part have been received in a quality storage due to problems in the production.

68. A method according to claim 59 wherein a percentile deviation of an actual inventory level of each part from the reorder level is shown.

69. A method according to claim 59 wherein information regarding last goods movements are provided on the manufacturer computer system.

70. A method according to claim 59 wherein information regarding planned goods movements are provided on the manufacturer computer system.

71. A method for automatic execution of orders of a manufacturer for parts at a vendor, comprising the steps of:
automatically detecting a demand for parts with aid of a manufacturer computer system; and
automatically providing data describing the demand for parts of a specific vendor, the data being provided as an actual inventory level and a reorder level over a data connection to at least one vendor computer system of the respective vendor, and wherein no separate work orders are generated.

72. A method according to claim 71 wherein a status signal is generated at the manufacturer computer system with regard to a respective part, the status signal is provided to the corresponding vendor computer system via the data connection, the status signal indicating whether a change of the corresponding part is not planned or is planned or has already been executed.

73. A method according to claim 72 wherein the status signal is shown in the form of a colored point on a graphical user interface, whereby the colored point is green when no change is planned, the colored point is yellow when a change is planned, and the colored point is red when a change has already been executed.

74. A method according to claim 72 wherein the status signal is shown in the form of a colored point on a graphical user interface, whereby the colored point is green when no corresponding goods are located in the quality storage and the colored point is red when the goods are located in the quality storage.

75. A method according to claim 71 wherein the data describing the demand for parts are automatically detected by means of a business management software.

76. A computer-readable medium, comprising a computer program which optimizes provision of production parts at a manufacturer where demand for parts is detected with a manufacturer computer system and data describing the demand are automatically provided over a data connection to at least one vendor computer system of a specific vendor, the computer program performing the steps of:
detecting the demand for parts;
automatically providing the data describing the demand over said data connection to said at least one vendor computer system of said specific vendor, the data describing the demand for parts to be delivered by the vendor as an actual inventory level and a reorder level; and
providing a graphical display at the vendor computer system concerning data for at least one of the parts inventory level, changes to the parts planned by the manufacturer, or parts quality.

77. A method for optimized provision of production parts at a manufacturer, comprising the steps of:
detecting a demand for parts with a manufacturer computer system;
automatically providing data describing the demand over a data connection to at least one vendor computer system of a specific vendor, the data describing the demand for parts as an actual inventory level and a reorder level; and
providing a display at the vendor computer system concerning data for at least one of the parts inventory level, changes to the parts planned by the manufacturer, or parts quality.
